(19) United States
(12) Patent Application Publication
(10) Pub. No.: US 2006/0050311 A1
(43) Pub. Date: Mar. 9, 2006

(54) Image-forming apparatus and a controlling method for the same

(76) Inventors: Takao Aichi, Tokyo (JP); Akitoshi Yamada, Kanagawa-ken (JP); Kazuyuki Masumoto, Kanagawa-ken (JP); Hiromitsu Hirabayashi, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/222,385

(22) Filed: Sep. 8, 2005

(30) Foreign Application Priority Data
Sep. 8, 2004 (JP) 2004-261569

(51) Int. Cl. G06F 3/12

(52) U.S. Cl. 358/1.15

(57) ABSTRACT

A DSC 1 (3012) and a DSC 2 (2012) are connected with each other via an interface different from that of a photo-direct printer 1000. When the job controller 1023 receives a job from the DSC 1 or DSC 2, it stores printing information, which is information on the job, and information on a source of the job, in a queuing buffer 1024 associated with each other. The job controller 1023 can accept printing information from the DSC 1 or the DSC 2 in parallel with a printing process. The job controller 1023 can also perform a canceling process of a job queued by using information on a source.

### FIELD OF THE INVENTION

The present invention relates to an image-forming apparatus which can directly communicate with an image-supplying apparatus such as a digital camera and a controlling method for the same.

### BACKGROUND OF THE INVENTION

In order to print an image taken by a digital still camera (including an appliance with a function of taking moving images or an appliance with a function of taking still images; hereinafter referred to as DSC), conventional arts usually read the taken images from the digital camera into a personal computer (hereinafter referred to PC) and print the images at a printer connected to the PC by using an application on the PC.

In other words, image data flows like DSC→PC→a printer. Conventional arts need to have a PC for printing an image taken by a DSC. The conventional arts also have a problem in that it has to start a PC or an application each time they print an image taken by a DSC.

In view of the problems, a technique of directly connecting a DSC and a printer to enable the DSC to issue an instruction directly to the printer (hereinafter referred to as photo-direct printing) has been proposed (see Japanese Patent Laid-Open No. 2004-70611).

The photo-direct printing technique is advantageous in that it can easily print an image without starting a PC as well as in that the system architecture is affordable at a low price as it does not need a PC. It is also advantageous in further reducing a cost as it needs no display device in particular on the printer for a user to check an image. The user uses a display device conventionally provided for the DSC as means for checking various instructions, particularly an image to be printed, when the DSC is connected to the printer.

In conventional arts, a printing from a PC to a printer connected to the PC is simply performed in this way: print data generated by a printer driver operating on the PC is unilaterally transferred from the PC to the printer and the printer successively processes the received print data. Thus, a printer does not designate necessary data and request a PC to send the data.

However, when direct printing is performed by using the photo-direct printing technique, it is preferable that a DSC to send a print instruction to a printer is only designation of an image desired to be printed and a print mode, i.e., printing information, and a printer requests the DSC to transfer image files required to perform an actual printing process sequentially and obtains image files stored in a storage medium held by the DSC.

If such an embodiment can not implemented, a printer is required to have the equal to or more storage than that of a recording medium held by a DSC, or a DSC is required to perform the same process as that performed by a printer driver on a PC. In such a case, even if a printer has interfaces that can connect the printer to a DSC and is adapted to receive data from a plurality of DSCs, the printer exclusively controls the interfaces for printing image data. Therefore, when a printer is receiving data via an interface and printing the data, the other interfaces are unavailable.

A photo-direct printing system is currently adapted for a configuration of a DSC and a printer connected one for one by wire. If communication between a DSC and a printer in the photo-direct printing will advance from wired communication to wireless communication in future, a printer is expected to be directly connected to a plurality of digital cameras. The conventional photo-direct printing techniques, however, are not developed enough in managing a plurality of job spools sent out from a plurality of digital cameras when the plurality of digital-cameras are directly connected with a printer.

If a plurality of PCs share a printer in a computer network, for example, and if only a spooler for managing spooled data or a PC, on which the spooler operates, is operating after a printing job is spooled, printing is performed correctly even if an application generated the spool data or a PC, on which the application is running, is disconnected from a network or powered off. In this case, as the PC, on which the spooler is operating, can manage the printing job, the PC can arbitrarily perform manipulation, for example deletion, on the job. As the PC, which made the spool data, is disconnected from the spooler, the PC cannot manage the job.

The same job management system as that in a computer network cannot be applied to the embodiment like a photo-direct printing, in which a printer side sequentially requests a DSC to transfer a photo-image file required for achieving actual printing processes and obtains the file. In other words, as printing information is previously sent from a DSC to a printer in the case of a photo-direct printing, the printer may hold many pieces of image information data in contrast to actual photo-image data. Therefore, the printer has to control jobs (printing information) inputted from a plurality of DSCS.

### SUMMARY OF THE INVENTION

The present invention is adapted in view of the problems in conventional arts, and intends to provide an image-forming apparatus, which enables efficient management of direct printing jobs from a plurality of sources and a method for the same.

According to an aspect of the present invention, there is provided an image-forming apparatus that can directly communicate with a plurality of image-supplying apparatuses and performs a printing process requested from the plurality of image-supplying apparatuses, comprising: receiving means for receiving information on a printing process from the plurality of image-supplying apparatuses; storing means for storing the information on a printing process received by the receiving means and information that can indicate an image-supplying apparatus, which is a source of the information, in a storing device associated with each other; and control means for performing each printing process based on the information on a printing process stored in the storage device.

According to another aspect of the present invention, there is provided a control method for an image-forming apparatus that can directly communicate with a plurality of image-supplying apparatuses and performs a printing process requested from the plurality of image-supplying apparatuses, comprising: a receiving step of receiving information on a printing process from the plurality of image-supplying apparatuses; storing step of storing the information on a printing process received at the receiving step and information that can indicate an image-supplying apparatus, which is a source of the information, in a storing device associated with each other; and a controlling step of performing each printing process based on the information on a printing process stored in the storage device.

According to another aspect of the present invention, there is provided a program for causing a computer to perform a control method for an image-forming apparatus that can directly communicate with a plurality of image-supplying apparatuses and performs a printing process requested from the plurality of image-supplying apparatuses, comprising programs of: a receiving step of receiving information on a printing process from the plurality of image-supplying apparatuses; a storing step of storing the information on a printing process received by the program of receiving step and information that can indicate an image-supplying apparatus, which is a source of the information, in a storing device associated with each other; and a controlling step of performing each printing process based on the information on a printing process stored in the storage device.

According to another aspect of the present invention, there is provided a computer-readable storage medium that stores a program according to the present invention.

According to the present invention, the abovementioned configuration enables direct printing jobs from a plurality of sources to be efficiently managed.

Other objects and advantageous besides those discussed above shall be apparent to those skilled in the art from the description of a preferred embodiment of the invention which follows. In the description, reference is made to accompanying drawings, which from a part thereof, and which illustrate an example of the various embodiments of the invention. Such example, however, is not exhaustive of the various embodiments of the invention, and therefore reference is made to the claims which follow the description for determining the scope of the invention.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an oblique illustration showing an exemplary appearance of a photo-direct printer according to an embodiment of the present invention;

FIG. 2 is a diagram showing how a DSC is directly connected with the PD printer shown in FIG. 1;

FIG. 3 is a block configuration diagram of a controlling system of the PD printer according to the embodiment;

FIG. 4 is a block diagram showing an exemplary configuration of a digital still camera in the embodiment;

FIG. 5 is a functional block diagram for illustrating a job management function in the PD printer in the first and the second embodiments;

FIG. 6 is a diagram showing a sequence of the DSC 1, DSC 2 and the PD printer 1000 and a state of the queuing buffer in the first embodiment;

FIG. 7 is a diagram showing a sequence of the DSC 1, DSC 2 and the PD printer 1000 and a state of the queuing buffer in the second embodiment; and

FIG. 8 is a functional block diagram for illustrating a job management function in the PD printer in the third embodiment.

### DETAILED DESCRIPTION OF THE PREFERRED EMBODIMENTS

Preferred embodiments of the present invention will now be described in detail in accordance with the accompanying drawings.

### First Embodiment

(Basic Configuration)

First, basic parts in the embodiment will be described. A mode of printing an image stored in a storage-medium in a digital still camera (DSC) in an environment where a printer can directly communicate with a DSC will be called a direct printing mode below. The DSC is not limited to a digital still camera. Rather, any direct-printing ready appliances can be applied as an alternative.

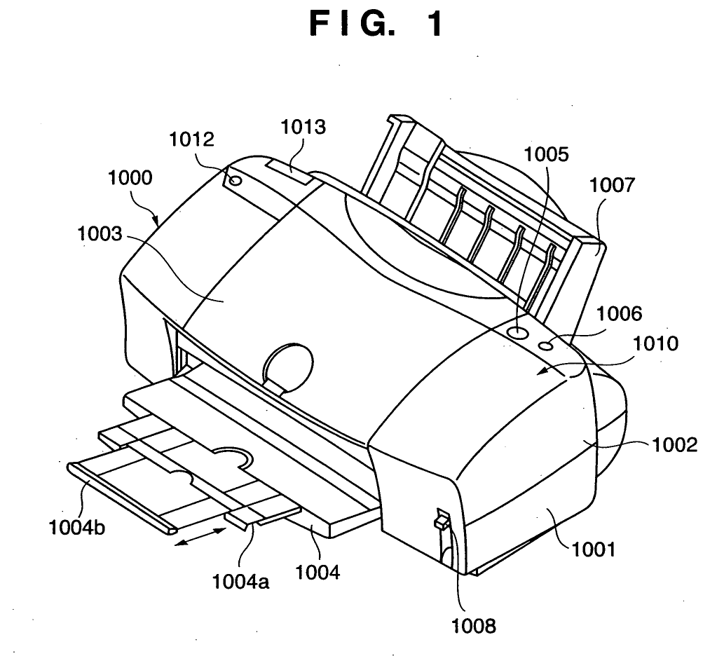

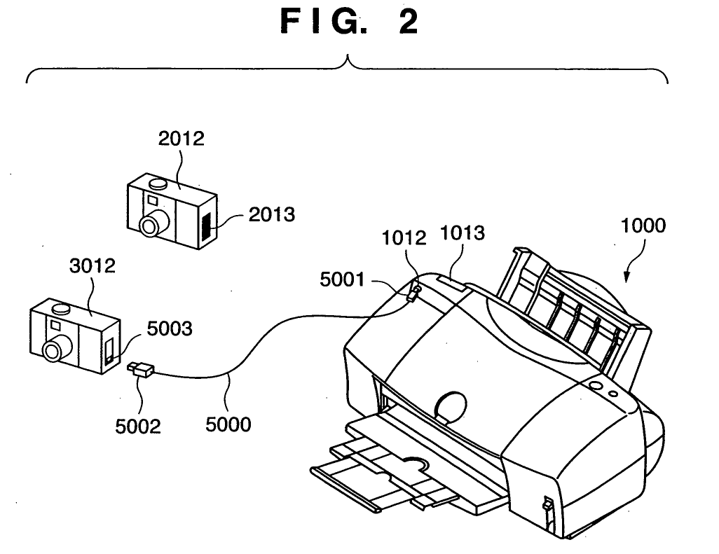

FIG. 1 is an oblique illustration showing an exemplary appearance of a photo-direct printer (called PD printer) as an image-forming apparatus according to the embodiment. FIG. 2 shows how a DSC as an image-supplying apparatus is directly connected with the PD printer shown in FIG. 1.

In FIG. 1, the PD printer 1000 has functions as a general PC printer which receives data from a host computer (PC) and prints the data. The PD printer 1000 also has functions of directly reading image data stored in a storage medium such as a memory card and printing the image data, or of receiving image data from a digital camera and printing the image data.

The body forming a shell of the PD printer 1000 has exterior components including a lower case 1001, an upper case 1002, an access cover 1003 and a paper output tray 1004. The lower case 1001 forms almost the lower half of the PD printer 1000 and the upper case 1002 forms almost the upper half of the PD printer 1000. The two cases are combined to form a hollow structure with a housing space for housing various mechanisms in to be described. The hollow structure has openings in a top and a front, respectively.

The paper output tray 1004 is rotatably held at its end by the lower case 1001. The end can freely flip or rotate on the lower case 1001 to open and close the opening formed at the front of the lower case 1001. With this mechanism, the end of the paper output tray 1004 is adapted to roll toward the front side to open the flap at the opening so that a recording medium such as a sheet of paper is outputted from the opening and the outputted recording media is stocked in order, when a recording (printing) operation is performed. The paper output tray 1004 houses two auxiliary trays 1004a and 1004b. The paper output tray 1004 is adapted to change the size of the support area for sheets for three levels when a user draws each of the auxiliary trays.

The access cover 1003 hinges on the upper case 1002 by an end and is adapted to open and close at the top of the upper case 1002. A user can exchange a recording head cartridge (not shown), an ink tank (not shown) or the like housed in the body by opening the access cover 1003. Although not shown in particular here, the embodiment is adapted to turn a cover open/close lever with a protrusion formed on the backside of the access cover 1003 when the access cover 1003 is opened or closed. The embodiment is adapted to detect whether the access cover is opened or closed by detecting the position of the lever with a micro switch or the like.

A power switch key 1005 is provided on the top of the upper case 1002 so that a user can press the key 1005. An operating state indicating unit 1006 is also provided on the top of the upper case 1002. The operating state indicating unit 1006 has a light emitting element such as a LED for a user to view and check whether the PD printer 1000 is in an operable state or not. An automatic feeding unit 1007 automatically feeds a stock of recording media into the body of the apparatus. A sheet distance selection lever 1008 is a lever for a user to adjust a distance between a recording head and a recording medium.

A wired communication unit 1012 is an interface for communicating with a digital camera to be described by wired connection. A digital camera usually has a USB (Universal Serial Bus) as a connecting interface to an external appliance such as a personal computer. In the PD printer 1000 of the embodiment, the wired communication unit 1012 is also considered to comply with a USB interface. The wired communication unit 1012, however, may be a wired communication interface other than a USB interface (for example, a serial interface such as IEEE1394, a parallel interface such as IEEE1284). The embodiment is adapted to connect with a digital camera at the front as shown to facilitate a connecting action.

The PD printer 1000 also has an interface for performing a print process instructed from a personal computer (PC). The PD printer 1000 keeps a connection with a PC once the connection is established, unless any special situation arises. Thus, the interface terminal (not shown) is provided on the back of the PD printer 1000. The connecting interface to a PC may be any interface that supports at least a bi-directional communication, such as a parallel interface from Centronics (IEEE1284) or a USB interface.

A wireless communication unit 1013 performs wireless communication with a DSC (to be described) or a PC that is available for wireless communication. The wireless communication unit supports communication complying with a wireless communication standard such as IEEE802.11a/b/g or Bluetooth, IrDA.

FIG. 2 schematically shows how the PD printer 1000 according to the embodiment and a digital camera 3012, which is wired-connection ready, or a digital camera 2012, which is wireless-connection ready, (both cameras have a photo-direct printing function) are connected.

In FIG. 2, a cable 5000 (USB cable) has a connector 5001 for connecting with a connector of the wired communication unit 1012 of the PD printer 1000 and a connector 5002 for connecting with a connector of the wired communication unit 5003 of the digital camera 3012. With the above connector 5001 connected with a USB connector of a PC, the digital camera 3012 and the PC can communicate with each other and an image taken by the digital camera 3012 can be transferred to the PC.

The digital camera 3012 is adapted to output image data saved in inner memory via the wired communication unit 5003. The digital camera 3012 can use a removable memory card or built-in memory as inner memory. With the PD printer 1000 and the digital camera 3012 connected with each other via the cable 5000 shown in FIG. 2, image data from the digital camera 3012 can be directly printed by the PD printer 1000.

The digital camera 2012 is adapted to output image data saved in inner memory via the wireless communication unit 2013. The digital camera 2012 has the same configuration as that of digital camera 3012 except for the wireless communication unit 2013.

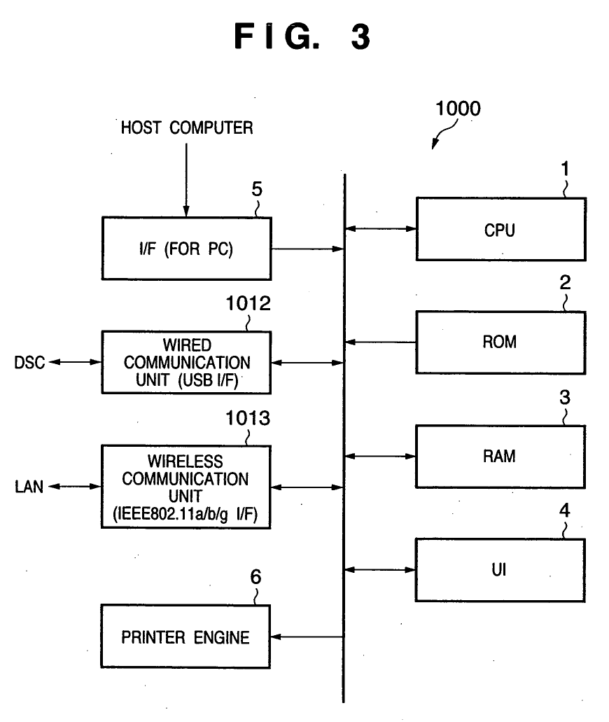

FIG. 3 is a block configuration diagram of a controlling system of the PD printer in the embodiment.

In FIG. 3, a CPU1 controls over the entire apparatus and ROM 2 stores operating processes (program) for the CPU 1 and fonts. RAM 3 is used as a work area of the CPU1. A user interface (UI) 4, corresponding to those denoted by 1005 and 1006 in FIG. 1, displays buttons, keys and the like manipulated by a user and a state of a printer. An interface 5 for PC is the IEEE1284 interface, for example. The wired communication unit 1012 communicates with a digital still camera by wired connection (in the embodiment, an USB interface (on a host side)). The wireless communication unit 1013 communicates with a digital still camera by wireless connection (in the embodiment, a wireless communication interface complying with IEEE802.11a/b/g). Although a printer engine 6 in the embodiment is a printer engine in a scheme of recording by discharging ink with thermal energy, it may be a printer engine in another recording scheme.

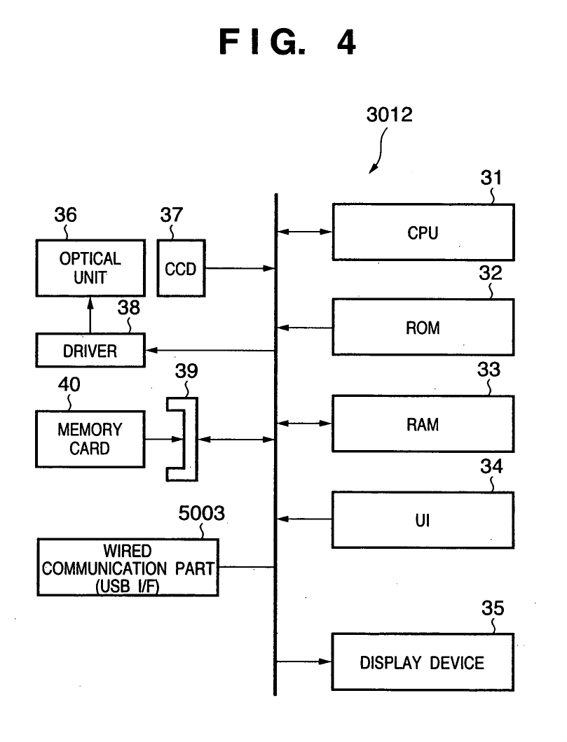

FIG. 4 is s a block diagram showing an exemplary configuration of the DSC (digital still camera) 3012.

In FIG. 4, a CPU 31 controls over the entire DSC, ROM 32 stores processes (program) for the CPU 31. RAM 33 is used as a work area of the CPU 31. A UI 34 is a group of switches for a user to perform various manipulations. A display device 35 is a LCD, for example, used for displaying a taken image for a user to check the image or menus for a user to perform various settings. An optical unit 36 mainly includes lenses and a driving system for the lenses (such as an auto-focus, zoom). A CCD 37 is an imaging device and a driver 38 controls the optical unit 36 under the control of the CPU 31. A connector (slot) 39 is attached with a removable storage medium 40 (memory card, micro drive, etc.). A wired communication unit (USB interface (on the slave side)) 5003 communicates with a PC or the PD printer 1000 in the embodiment by wired connection.

The digital camera 2012 has a configuration shown in FIG. 4 with the USB interface 5003 is changed to the wireless communication unit 2013 (wireless interface complying with IEEE802.11a/b/g).

Configurations of the PD printer 1000 of the embodiment and the DSCs 2012 and 3012 have been described. A job management process based on the configurations will be described below.

(Job Management Function Configuration of the PD Printer)

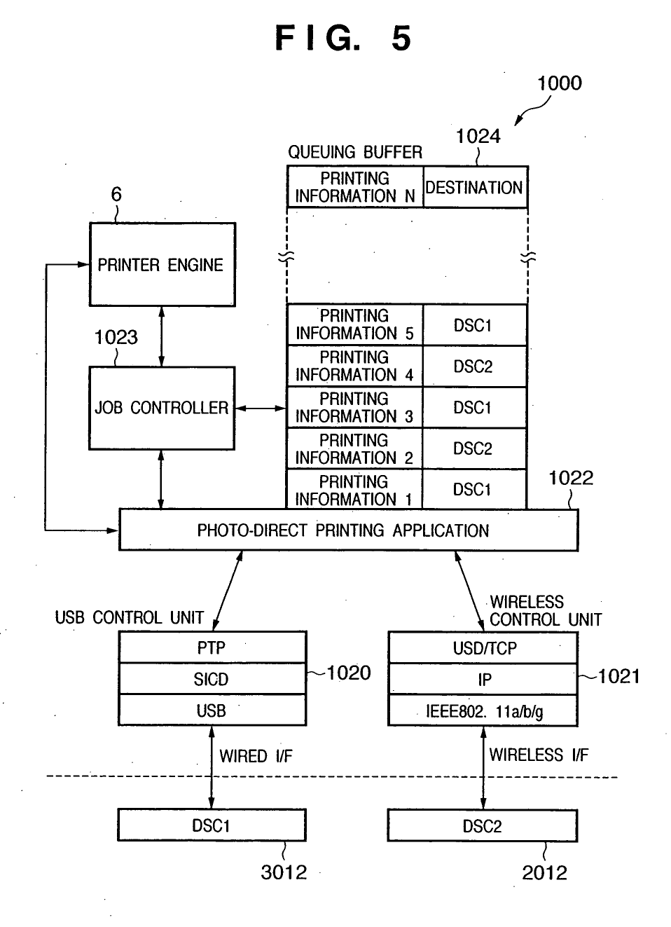

FIG. 5 is a functional block diagram for illustrating a job management function in the photo-direct printer 1000.

The reference number 1020 denotes a USB control unit for receiving data via a wired communication I/F (USB interface in the embodiment), which uses a still image class device (SICD) as an image class and PTP for a transfer protocol in the example of FIG. 5. The reference number 1021 denotes a wireless control unit for receiving data via a wireless communication I/F (wireless interface complying with IEEE802.11a/b/g in the embodiment).

For example, a photo-direct printing application 1022 stored in the ROM 2 and executed by the CPU 1 stays higher than the physical layer and the protocol layer of a wired/wireless interface. The application 1022 controls printing information from a DSC or commands such as status information (for example, error information) from a printer. The application 1022 has the printing information stored in a queuing buffer 1024 provided as a partial region on the RAM 3 via a job controller 1023 to be described later.

Then the job controller 1023 references the printing information stored in the queuing buffer 1024 and causes the photo-direct printing application 1022 to request the DSC to send real printing data (taken image data). In response to the request, the photo-direct printing application 1022 passes data sequentially sent out from the DSC to the printer engine 6, which prints the data.

The USB control unit 1020 and the wireless control unit 1021 in the function block shown in FIG. 5 correspond to the wired communication unit 1012 and wireless communication unit 1013 in FIG. 3. A part or all of the functions of the USB control unit 1020 and the wireless control unit 1021 can be implemented as software by the CPU 1.

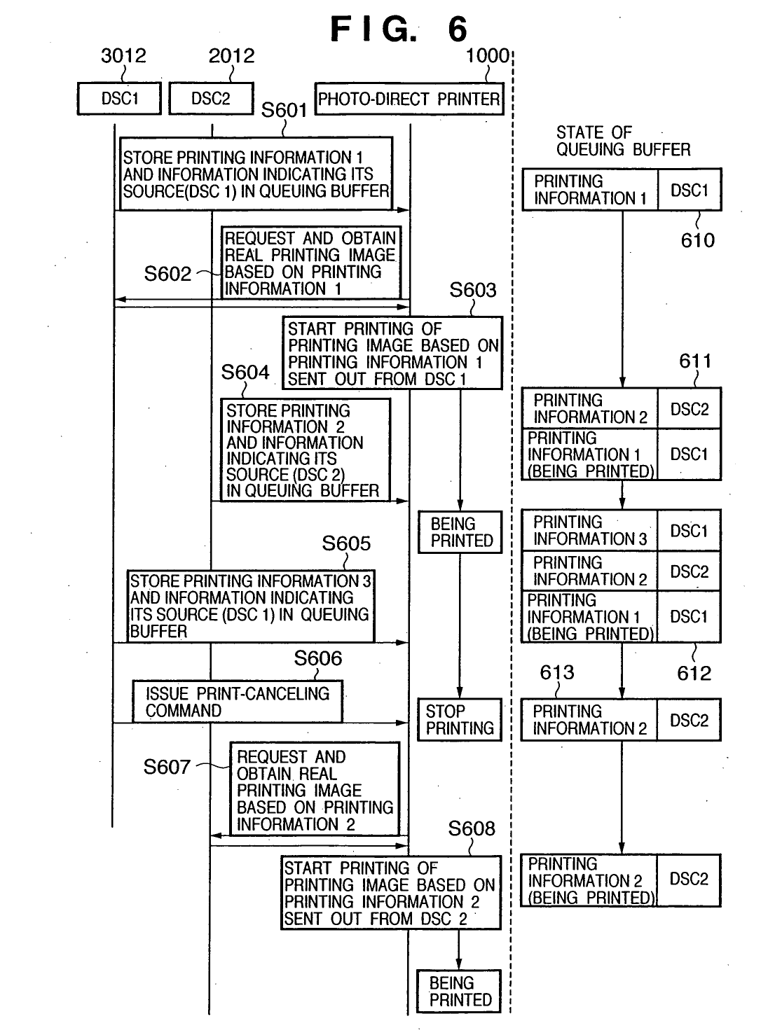

As mentioned above, the PD printer 1000 of the embodiment has a plurality of communication interfaces (two in the embodiment) with a DSC. Thus, the job controller 1023 has a system of storing and referencing the source of queuing data (printing information), i.e., the DSC 1 (3012) or the DSC2 (2012). A specific case of controlling photo-direct printing from both the DSC 1 and the DSC 2, i.e., a case of two interfaces being connected, will be described below with reference to FIG. 6 that is a sequence diagram for the DSC 1, the DSC 2 and the PD printer 1000.

At step S601, as the DSC 1 (3012) sends out printing information 1, the printing information 1 is transmitted to the job controller 1023 via the USB control unit 1020 and the photo-direct printing application 1022. The job controller 1023 associates the printing information 1 and information indicating the DSC 1 as the source and stores them in the queuing buffer 1024 (610). The information indicating the source may be any information that can indicate the DSC. An ID, an address or the like included in data sent from the DSC can be used as the information.

When the job controller 1023 determines image data required for printing (real printing images) based on the printing information 1 stored in the queuing buffer 1024, it prompts the photo-direct printing application 1022 to request the real printing image data from the DSC 1. The photo-direct printing application 1022 requests the real printing image data from the DSC 1 (3012) via the USB control unit 1020. As the photo-direct printing application 1022 obtains the real printing images sent out from the DSC 1, it transfers the real printing images to the printer engine 6 and orders a printing operation. The photo-direct printing application 1022 may prompt the printer engine 6 to perform a printing operation after it obtained all the real printing images relating to the printing information 1. Then, the printer engine 6 starts printing the received real printing images based on the printing information 1 stored in the queuing buffer 1024 (step S603).

Subsequently, the job controller 1023 determines whether the PD printer 1000 can queue more printing information based on predetermined conditions such as a load on the CPU 1, free space in the queuing buffer 1024, and the number of jobs queued. If the PD printer 1000 can queue more printing information, the job controller 1023 informs the DSC 1 and the DSC 2 that the printer can receive printing information via both of the USB control unit 1020 and the wireless control unit 1021.

The PD printer 1000 cannot accept a job (receive printing information) in such a case as the CPU 1 is under high load, for example in converting JPEG data into printing data, or as the queuing buffer 1024 has little free space. The PD printer 1000 in the embodiment, however, informs the DSC 1 and the DSC 2 that it can accept printing information and accepts printing information in an acceptable state. The DSC 1 and the DSC 2 may send printing information after receiving this information from the printer.

Here, it is assumed that the second printing information 2 is sent from the DSC 2 (2012) (step S604). The printing information 2 is also stored in the queuing buffer 1024 by the job controller 1023 as the printing information 1 is stored. Information indicating the source of the printing information 2 is also stored with the printing information 2 (611). At this moment, the PD printer is printing a real printing image, while requesting a real printing image from the DSC 1 via the photo-direct printing application 1022 with reference to the printing information 1, and does not obtain a real printing image relating to the printing information 2.

If the PD printer 1000 can queue more printing information after queued the printing information 2, the job controller 1023 informs the DSC 1 and the DSC 2 that the printer can receive printing information via both of the USB control unit 1020 and the wireless control unit 1021 again.

When the third printing information 3 is sent out from the DSC 1 (step S605), the job controller 1023 stores the printing information 3 with information indicating its source into the queuing buffer 1024 (612).

If the PD printer 1000 can queue more printing information, the job controller 1023 informs each DSC that the printer can receive printing information. When the PD printer 1000 finishes a printing process, it deletes the printing information relating to the process from the queuing buffer 1024 and starts a process based on the next printing information in the queue. The PD printer 1000 performs a process, while accepting jobs received from a plurality of DSCs by repeating the abovementioned processes.

Now, a process performed in a case that either the DSC 1 or the DSC 2 issues a cancel command (Abort command) to a printer will be described. It is assumed that the DSC 1 issues a cancel command (step S606). The job controller 1023 receives this cancel command. When the job controller 1023 detects that the cancel command is from the DSC 1, it deletes all the printing information originated in the DSC 1 from the queuing buffer.

Then, the printing information 2 sent from the DSC 2 in the next place becomes the first in, the queuing buffer 1024 (613). The job controller 1023 has the PD printer to obtain a real printing image from the DSC 2 by using the photo-direct printing application 1022 and to start printing by using the printer engine 6 (step S608).

If the DSC 2 issues a cancel command, the job controller 1023 only needs to delete the printing information 2 originated in the DSC 2, which is in the next place in the queue, from the queuing buffer 1024. For simplifying the understanding, the cases that one to three pieces of printing information are queued is described above, though, a printer may have a plurality of (N) queuing buffers 1024 in consideration of capacity of the built-in memory or the like, as shown in FIG. 5.

Only the data currently printed by the printer is deleted in response to some types of cancel commands from the DSC. In such a case, unprocessed printing information in the queuing buffer 1024 may not be deleted. All the queued printing information and data currently printed may be canceled without regard to the source.

Unlike a cancel command issued from a DSC, when a cable is pulled out in wired connection or when a power supply or the like of a DSC is shut off but if only a printer has obtained all the data to be printed, a printing operation needs not to be stopped. It is a matter of course that the printing operation may be stopped.

When a communication is interrupted, the PD printer cannot obtain a real printing image relating to the printing information in the queue at the moment unless the connection is recovered thereafter. Therefore, in the embodiment, all the printing information (job) that has been received from the disconnected apparatus is cancelled (from the queuing buffer 1024). This is preferable as the PD printer cannot receive image data from the disconnected apparatus and not perform the already received jobs. Alternatively, the PD printer may hold the jobs and not to delete the jobs immediately considering that the connection is recovered soon. The PD printer may hold jobs for a predetermined time period from when the communication is disconnected so that the jobs are held over a temporally disconnection of the communication. The communication may be temporally disconnected and recovered soon such as when radio waves are unstable or when a battery is exchanged, for example. It is inconvenient if the PD printer deletes all the jobs in such a case, for the printer needs a printing instruction again. Jobs can be controlled in this way as the job controller 1023 stores printing information with a source of the image information in the queuing buffer 1024.

As such, according to the embodiment, a photo-direct printer with a plurality of interfaces can receive a job from a DSC by using the plurality of interfaces concurrently. The photo-direct printer can also achieve an efficient management of jobs and flexible response to a control from the source.

According to the embodiment, a printer informs a plurality of DSCs that it can accept printing information and accepts printing information from a DSC in an acceptable state. Therefore, the DSC 1 and the DSC 2 can get timing which it can send printing information to the printer and need not to send printing information repeatedly until it is accepted.

In the embodiment, the case that a printer has two DSCs, though, it is a matter of course that the embodiment can also apply to a case that a printer has more than two DSCs, such as when a printer has two or more DSCs which can be communicated wirelessly.

### Second Embodiment

In the first embodiment, data queued in the queuing buffer 1024 by the job controller 1023 is only the printing information (and information of its source). Some printers, however, have large capacity of storage, which can queue real printing images (JPEG images or the like).

In other words, in a general photo-direct printing system, real printing images are only stored in storage on a DSC side and a printer obtains real printing images if needed. Printing images may be sent out to a printer side up to the amount that the storage of the printer can save.

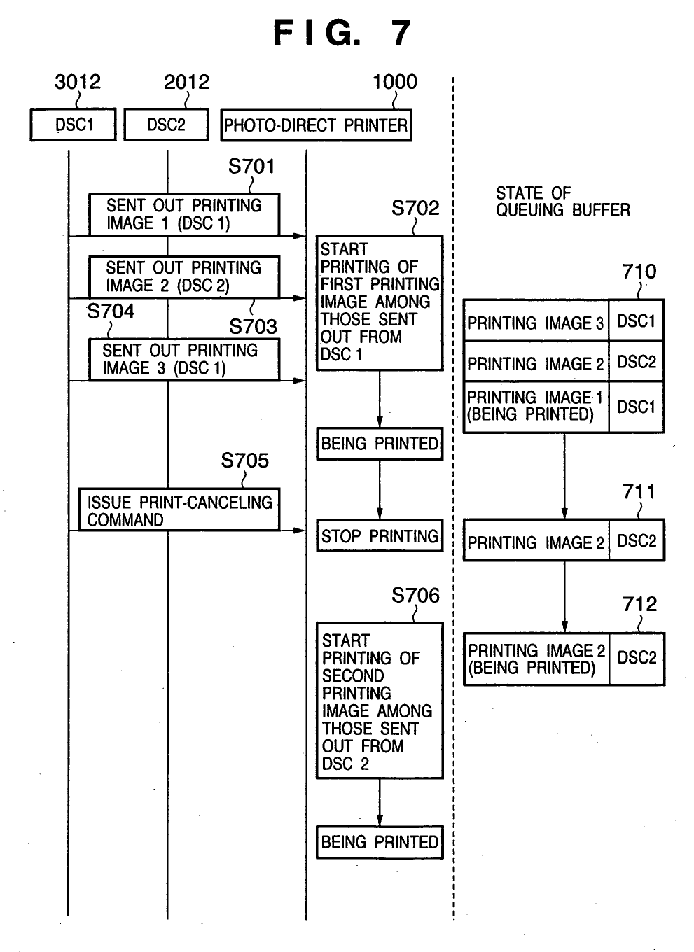

In the embodiment, a case that the job controller 1023 performs multi-queuing of real printing images will be described with reference to FIG. 7.

First, when the job controller 1023 can queue a printing image, it informs the DSC 1 and the DSC 2 that it can receive a printing image via the USB control unit 1020 and the wireless control unit 1021.

In response to this information, a printing image 1 (and printing information) is assumed to be sent out from the DSC 1 (step S701). When the job controller 1023 of the photo-direct printer 1000 receives the first printing image 1 sent out from the DSC 1 via the USB control unit 1020 and the photo-direct printing application 1022, it stores the printing image 1 and its source information into the queuing buffer 1024. When the job controller 1023 has obtained all the data of the printing image 1, it issues a printing command to the printer engine 6 (step S702).

Then, the job controller 1023 informs the DSC 1 and the DSC 2 that it can receive another printing image via both of the USB control unit 1020 and the wireless control unit 1021.

In response to this information, the DSC 2 sends a printing image 2 (step S703), and the job controller 1023 stores it in the queuing buffer 1024. In the same manner, the DSC 1 sends a printing image 3 (step S704) and it is stored in the queuing buffer 1024 (710).

Although the PD printer starts to print the printing image 1 immediately after it received the image, the printer can start to print the first image after a plurality of images (for example three images) are queued in the queuing buffer.1024.

Processes performed by the job controller 1023 to determine whether the printer can receive a printing image or not based on a free space in the queuing buffer 1024 and to have images queued and printed are the same as what described in the first embodiment. In the embodiment, information relating to a printing mode is sent out from a source DSC with a printing image or prior to the printing image. The printing information is stored in the queuing buffer 1024 with a printing image. If manipulation such as deletion is performed on the printing image, the printing information is also manipulated in the same way.

It is assumed that the DSC 1 issues a cancel command while the printer is printing the printing image 1. When the job controller 1023 receives the cancel command from the DSC 1 via the photo-direct printing application 1022, it stops printing of the printing image 1 and deletes printing images, whose sources are DSC 1, from the queuing buffer 1024. As a result, only the printing image 2 whose source is the DSC 2 remains in the queuing buffer 1024 (711). Then, the job controller 1023 issues a command for printing the printing image 2 to the printer engine 6 (step S706).

As described in the first embodiment, the job controller 1023 deletes only data currently printed from the buffer in response to some kinds of cancel command from a DSC. In such a case, the job controller 1023 does not delete an unprocessed printing image among the images stored in the queuing buffer 1024.

Now, a case that a communication is interrupted by not a cancel command but by a user pulling out a cable by mistake or the like will be described. In FIG. 7, when the job controller 1023 detects that a communication between the printer and the DSC 1 is interrupted during printing of the printing image 1 via the USB control unit 1020 and the photo-direct application 1022, the job controller 1023 may perform any of the four processes below:

1. Not stops printing (unless printing image data is not taken into the printer because of timing of obtaining the image).

2. Deletes all the printing images from the DSC 1 including a printing image currently printed and starts printing of the printing image 2 from the DSC 2.

3. Stops processing of only the image currently printed (the printing image 1).

4. Deletes all the printing images in the queue without regard to their sources.

When a wireless communication from the DSC 2 is interrupted for some reason, while the printing image 1 is printed in FIG. 7, the job controller 1023 may also perform any of the four processes below:

1. Not stops printing.

2. Deletes all the printing images queued whose sources are the DSC 2 (here, the printing image 2).

3. Cancels only a printing image currently printed whose source is the DSC 2 (here this process is not performed as the source of the image currently printed is DSC 1).

4. Deletes all the printing images in the queue without regard to their sources.

The job controller 1023 can determine which process to perform based on setting done in advance or user's selection. This kind of control over jobs is also enabled by the job controller 1023 as it stores a source of image information along with a printing image in the queuing buffer 1024.

Also according to the embodiment, a photo-direct printer with a plurality of interfaces can receive a job from a DSC by using the plurality of interfaces concurrently. The photo-direct printer can also achieve an efficient management of jobs and flexible response to a control from the source.

### Third Embodiment

In the first and the second embodiments, the job stored in a queuing buffer of a photo-direct printer can be manipulated only by a DSC which is a source of a job can (for example, cancel), except for a case that all the jobs are forcefully deleted without regard to their sources.

That is to say, a job from the DSC 1 can be manipulated only through the UI screen or the like on the DSC 1 and a job from the DSC 2 can be manipulated (canceled or asked to display the name of a printing image) only through the UI screen or the like on the DSC2, in FIG. 5. In the third embodiment, either of the DSCs can issue a command for displaying the name of an image or aborting a print process for the job of the other DSC. When printing information or a printing image is sent out from a DSC to a printer, the DSC sends information indicating whether the other DSCs connected by the other I/F can reference the job or not.

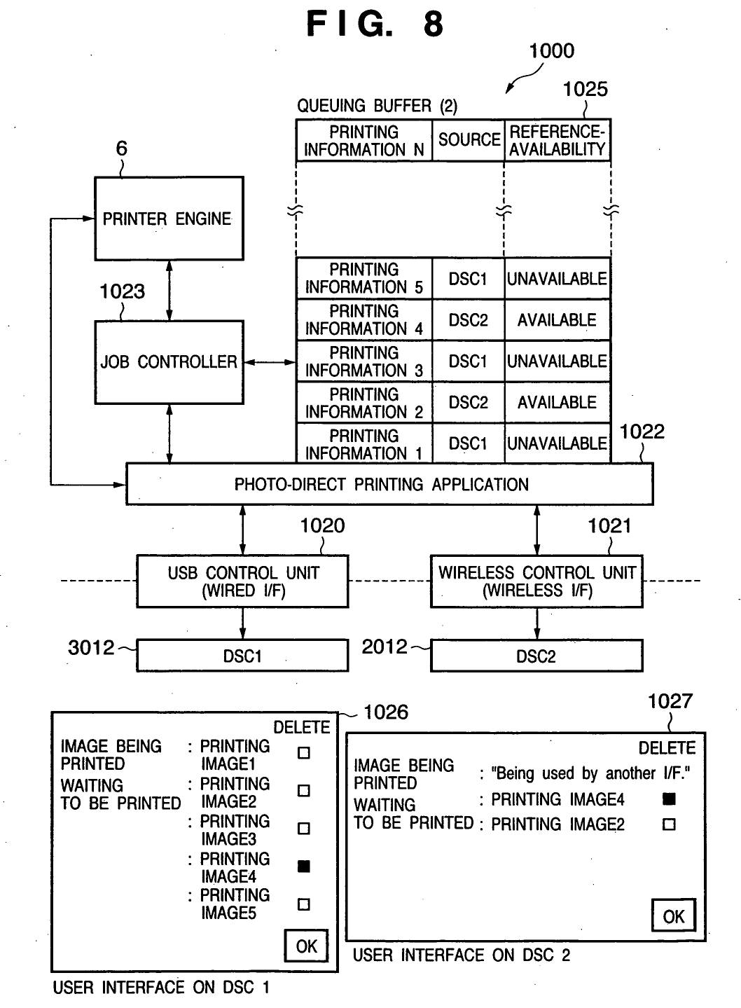

FIG. 8 shows a functional block diagram of the PD printer 1000 according to the embodiment and an exemplary GUI screen displayed on the DSC 1 and 2.

In this embodiment, although what is queued in a queuing buffer 1025 is assumed to be printing information as in the first embodiment, it can be a real printing image as described in the second embodiment.

As shown in FIG. 8, a reference-availability field is added to the queuing buffer 1025 in this embodiment. The reference-availability field stores reference-availability information indicating whether appliances other than the source are permitted to manipulate the job or not.

The job controller 1023 receives printing information including the reference-availability information from a DSC in step S601 of FIG. 6, for example. When the job controller 1023 stores the printing information in the queuing buffer 1025, it stores the reference-availability information in addition to the source information.

Then, the job controller 1023 enables a job whose reference-availability information is “available” to be displayed on the other interface or the UI on the other DSC, and disables a job whose reference-availability information is “unavailable” to be displayed on the other interface or the UI on the other DSC.

In the example shown in FIG. 8, among five jobs currently stored in the queuing buffer 1025, reference-available information for the jobs whose sources are the DSC 1 is set “unavailable”, and reference-available information for the jobs whose sources are the DSC 2 is set “available”. In this case, information relating to the jobs whose sources are the DSC 1 is not displayed on the UI of the DSC 2, and information relating to the jobs whose sources are the DSC 2 is displayed on the UI of the DSC 1, enabling a user to manipulate, for example delete, the job.

When the job controller 1023 is requested for job information from a DSC, it references reference-availability information for the queuing buffer 1025. Then the job controller 1023 sends information for displaying a user interface for a user to reference or manipulate a job (a printing process) that is permitted to be referenced or manipulated on the requesting DSC, i.e., a job whose source is the DSC and a printing process whose reference-availability information is available on the DSC. Alternatively, the job controller 1023 may inform the DSC of all the information queued along with the reference-availability information at a predetermined timing via the USB control unit 1020 and the wireless control unit 1021 and display an interface according to the source information and reference-availability information on the DSC side.

As a result, the DSC 1 is enabled to reference a job whose source is the DSC 2. Therefore, information on all the jobs currently stored in the queuing buffer 1025 including the jobs of the DSC 1 can be displayed as a GUI screen 1026, for example, on the display device 35 of the DSC 1. A user selects to delete, for example, an image currently printed or waiting to be printed with a well-known operating system such as a cursor key if needed, then selects “OK” on the screen to execute the process. In this manner, a cancel command for a job is issued from the DSC 1 to the PD printer 1000.

As the jobs whose sources are the DSC 1 are set “unavailable” for being referenced from the other appliances, only information relating to the jobs send out from the DSC 2 is displayed on the GUI screen 1027 on the display device 35 of the DSC 2. It is assumed that the job stored in the first place of the queuing buffer 1025 and included in currently printed information is set “unavailable” for being referenced as in the example of FIG. 8. In this case, only a message “Being used by another I/F” appears on the screen without information on the job, informing a user merely that the job from another appliance is currently processed. Therefore, only on the job sent from the DSC 2 can be manipulated, for example referenced or deleted, from the DSC 2 as in the conventional manner.

As such, the embodiment can improve convenience of a connected DSC in addition to effects of the first and the second embodiments by storing reference-availability information as well as source information.

### Other Embodiments

In the abovementioned embodiments, a method of broadcasting to DSCs that the PD printer 1000 can accept printing information as a method for the PD printer 1000 to accept a job (printing information) without exclusively processing a plurality of interfaces (a plurality of DSCs). The other methods can also be used in the present invention as described below.

For example, it is assumed that a DSC first sends a request indicating that it wants to perform a printing process (job request) and a printer in tern requests the DSC to send printing information. As a high-load on a CPU of the printer, for example, prevents the printer from receiving the job request from the DSC, or responding to the request, if received, the printer cannot queue the job as it is.

When the DSC does not get any response from the printer after it sent a job request, it waits for acceptable state information that is sent from the printer as the printer enters a state that it can receive printing information. When the DSC receives the receivable state information from the printer, it requests a job from the printer again.

This control also enables a printer to accept and queue a job from a plurality of DSCs according to a state of the printer. Other methods also can be used here.

The case that a software program for implementing functions of the abovementioned embodiments is supplied to a system or an apparatus with a computer which can execute the program directly from a recording medium or by wired/wireless communication and the same functions are achieved by the computer of the system or the apparatus executing the program is also included in the present invention.

Therefore, program codes supplied to and installed on a computer to implement functional processes of the present invention on the computer also implement the present invention. The computer program for implementing functional processes of the present invention is also included in the present invention.

Here, the program may be in any form if only it has a function of a program, such as an object code, a program executed by an interpreter, and script data supplied to an OS.

Storage media for supplying a program may include a flexible disk, a hard disk, magnetic storage medium such as a magnetic tape, an optical/magnetic optical storage medium including an MO, a CD-ROM, a CD-R, a CD-RW, a DVD-ROM, a DVD-R and a DVD-RW, and non-volatile semiconductor memory.

Means for supplying a program by wired/wireless communication may include a method of storing a computer program itself forming the present invention on a server on a computer network or a data file that may be a computer program (program data file) forming the present invention on a client computer such as a compressed file including an automatic installing function, and downloading the program data file to the client computer connected. In this case, the program data file can be divided into a plurality of segment files and the segment files can be located on different servers.

That is to say, a server device for enabling users to download a program data file for implementing the functional processes of the present invention on a computer is included in the present invention.

It is also possible to encrypt a program of the present invention, store the encrypted program in a storage medium such as a CD-ROM and deliver the storage medium among users, supply users who satisfies predetermined conditions with key information to decrypt the encrypted program, enabling the users to execute and install the encrypted program to a computer by using the key information.

The functions of the abovementioned embodiments can also be implemented by a computer to execute the read program. The functions of the abovementioned embodiments can also be implemented by an OS operating on a computer to execute a part or all of the actual processes according to the instructions of the program.

The functions of the abovementioned embodiments can also be implemented by a CPU or the like provided on an extended board inserted in a computer or an extended unit connected to a computer to perform a part or all of the actual processes according to the instructions of the program after a program read out from a recording medium is wrote on the extended board or the extended unit.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-261569 filed on Sep. 8, 2004, the entire contents of which are hereby incorporated by reference herein.

What is claimed is:

1. An image-forming apparatus that can directly communicate with a plurality of image-supplying apparatuses and performs a printing process requested from the plurality of image-supplying apparatuses, comprising:
receiving means for receiving information on a printing process from the plurality of image-supplying apparatuses;
storing means for storing the information on a printing process received by the receiving means and information that can indicate an image-supplying apparatus, which is a source of the information, in a storing device associated with each other; and
control means for performing each printing process based on the information on a printing process stored in the storage device.

2. The image-forming apparatus according to claim 1, wherein the storing means stores pieces of the information on a printing process sequentially as they are received by the receiving means.

3. The image-forming apparatus according to claim 1,
wherein the information on a printing process includes information that can indicate image data to be printed but the image data to be printed; and
wherein the control means obtains the image data to be printed from an image-supplying apparatus, which is a source of the information on a printing process, based on the information that can indicate image data to be printed.

4. The image-forming apparatus according to claim 1, wherein the information on a printing process includes image data to be printed.

5. The image-forming apparatus according to claim 1, wherein the information on a printing process includes reference-availability information indicating whether or not image-supplying apparatuses other than the source are permitted to reference or manipulate the printing process.

6. The image-forming apparatus according to claim 5, wherein the control means outputs information for displaying a user interface for a user to reference or manipulate a printing process permitted to be referenced or manipulated on the image-supplying apparatuses other than the source and a printing process whose source is the image-supplying apparatus, on the image-supplying apparatuses based on the reference-availability information on the image-supplying apparatuses to the image-supplying apparatuses.

7. The image-forming apparatus according to claim 5, wherein the control means outputs the information on a printing process, the information that can indicate the source and the reference-availability information stored in the storing means to the image-supplying apparatuses.

8. The image-forming apparatus according to claim 1, wherein when the receiving means receives a cancel command from any of the plurality of image-supplying apparatuses, the control means performs any of the processes below:
1) Continues a printing process being performed, whose source is the image-supplying apparatus sent the cancel command, without stopping;
2) Deletes the information on a printing process, whose source is the image-supplying apparatus that sent the cancel command, and all the other corresponding information from the storing device;
3) Deletes all the information stored in the storing device; and
4) Stops a printing process being performed, whose source is the image-supplying apparatus that sent the cancel command.

9. The image-forming apparatus according to claim 1, wherein the receiving means receives the information on a printing process from the plurality of Image-supplying apparatuses whether or not a printing process is being processed.

10. The image-forming apparatus according to claim 1,
wherein the control means informs the plurality of image-supplying apparatus that the information on a printing process can be received; and
wherein the receiving means receives the information on a printing process sent form the plurality of image-supplying apparatuses, in response to the information from the control means.

11. The image-forming apparatus according to claim 1,
wherein the receiving means
in response to receiving a sending request from the plurality of image-supplying apparatus, sends a sending request for requesting to send the information on a printing process from the image-supplying apparatus, which sent the sending request; and
receives the information on a printing process sent by the image-supplying apparatus, which is a source of the sending request, in response to the sending request from the receiving means.

12. A control method for an image-forming apparatus that can directly communicate with a plurality of image-supplying apparatuses and performs a printing process requested from the plurality of image-supplying apparatuses, comprising:
a receiving step of receiving information on a printing process from the plurality of image-supplying apparatuses;
a storing step of storing the information on a printing process received at the receiving step and information that can indicate an image-supplying apparatus, which is a source of the information, in a storing device-associated with each other; and
a controlling step of performing each printing process based on the information on a printing process stored in the storage device.

13. The control method for an image-forming apparatus according to claim 12, wherein the information on a printing process includes reference-availability information indicating whether or not image-supplying apparatuses other than the source are permitted to reference or manipulate the printing process.

14. A program for causing a computer to perform a control method for an image-forming apparatus that can directly communicate with a plurality of image-supplying apparatuses and performs a printing process requested from the plurality of image-supplying apparatuses, comprising programs of:
a receiving step of receiving information on a printing process from the plurality of image-supplying apparatuses;
a storing step of storing the information on a printing process received by the program of receiving step and information that can indicate an image-supplying apparatus, which is a source of the information, in a storing device associated with each other; and
a controlling step of performing each printing process based on the information on a printing process stored in the storage device.

15. A computer-readable storage medium that stores a program according to claim 14.
